(19) United States
(12) Patent Application Publication
(10) Pub. No.: US 2015/0215821 A1
(43) Pub. Date: Jul. 30, 2015

(54) METHOD AND APPARATUS FOR TIME-OF-DEPARTURE (ToD) ADJUSTMENT BASED ON TIME-OF-ARRIVAL (ToA) CORRECTION

(71) Applicant: QUALCOMM Incorporated, San Diego, CA (US)

(72) Inventors: Lei ZHANG, New Brunswick, NJ (US); Sundar SUBRAMANIAN, Bridgewater, NJ (US); Ying WANG, Easton, PA (US); Xinzhou WU, Hillsborough, NJ (US); Carlos ALDANA, Mountain View, CA (US); Xiaoxin ZHANG, Fremont, CA (US)

(73) Assignee: QUALCOMM Incorporated, San Diego, CA (US)

(21) Appl. No.: 14/167,749

(22) Filed: Jan. 29, 2014

(51) Int. Cl. H04W 28/18; H04W 4/02

(52) U.S. Cl. CPC H04W 28/18; H04W 4/028; H04W 4/04

(57) ABSTRACT

Implementations of the technology described herein provide adjustment to the time-of-departure (ToD) of the start of the acknowledgement frames (ACK) based on the time-of-arrival (ToA) estimation and correction of their corresponding message frames to keep the turnaround time of the acknowledgement frames stable to a predefined order of precision, with special applications for Wi-Fi ranging to achieve double-sided time-of-arrival (ToA) correction accuracy with minimal frame exchanges. A receiving station uses its time-of-arrival (ToA) correction to adjust the transmission time of an acknowledgement message (ACK) so that both the sending station and the receiving station can estimate round trip time (RTT) (or perform ranging) at the same level or higher accuracy.

### FIELD OF DISCLOSURE

The technology described herein is directed to wireless communication networks, and in particular, to Wi-Fi ranging in wireless communication networks.

### BACKGROUND

Being able to locate mobile devices with high accuracy has great importance in many applications such as public safety (e.g., automotive/pedestrian safety), military, and commercial applications. With the availability of Global Positioning System (GPS) and Wi-Fi in mobile devices, many location-aware applications have been enabled. Often in harsh propagation environments where Global Positioning System (GPS) fails, such as in urban canyons, inside buildings, inside caves, or during inclement weather, Wi-Fi ranging can provide an alternative means for positioning (i.e., determining the location of a mobile device). Even when the conditions are good for Global Positioning System (GPS), Wi-Fi ranging can help improve the positioning accuracy of Global Positioning System (GPS).

The Institute of Electrical and Electronics Engineers (IEEE) 802.11 standards specify how Wi-Fi is to be used to perform ranging to determine the distance from a sending station (e.g., a mobile device) to a receiving station (e.g., a base station). Typically, Wi-Fi ranging chooses either signal-strength-based or time-of-arrival (ToA)-based approaches. The time-of-arrival (ToA)-based approach, which is being added into 802.11 standards, can deliver significant performance improvements over signal-strength-based approaches.

In a conventional time-of-arrival (ToA)-based approach, the sending station transmits a frame, called a timing measurement frame (M) in 802.11, at time t1, and the receiving station receives the timing measurement frame (M) at time t2. At some time later, the receiving station transmits an acknowledgement frame (ACK) to the sending station at time t3. The time between t2 and t3 is fairly constant, up to tens of microseconds according to 802.11 standards. The sending station receives the acknowledgement frame (ACK) at time t4.

In this scenario, there are two times at each side: time-of-departure (ToD) and time-of-arrival (ToA). When the sending station receives the acknowledgement frame (ACK), the sending station transmits a second timing measurement frame (M) to the receiving station. The second timing measurement frame (M) incorporates the times t1 and t4. The receiving station now has four times: t1, t2, t3, and t4 (i.e., times t1 through t4 are known by the receiving station). Based on these time stamps t1-t4 the receiving station can estimate the round trip time (RTT) and as a result can estimate the distance between the sending station and the receiving station.

One problem with this approach is that the original times t2 or t3 do not incorporate the time-of-arrival (ToA) correction (e.g., correction for delays introduced by the environment and/or other factors) at the receiving station. The sending station conventionally does the time-of-arrival (ToA) correction for time t4. Thus, after the first acknowledgement frame (ACK), the sending station can only estimate the round trip time (RTT) by incorporating a one-sided (i.e., its own side) time-of-arrival (ToA) correction. Moreover, it is only after the second timing measurement frame (M) is received at the receiving station that the receiving station is able to perform its estimate of the round trip time (RTT).

As such, techniques are needed to improve distance-ranging using the IEEE 802.11 standards.

### SUMMARY

Example implementations of the technology described herein are directed to a mechanism for time-of-departure (ToD) adjustment based on time-of-arrival (ToA) correction. In one or more implementations, the mechanism includes systems, methods, apparatuses, and (non-transitory) computer readable media that implement the technology described herein.

In one or more implementations, a method for adjusting a transmission time of an acknowledgement to a message for a first station in a wireless communication network includes receiving, at the first station, a first message at a first message reception time t2, wherein the first message was transmitted by a second station at a first message transmission time t1. The first message has a first message duration time. The method also includes transmitting, at the first station, a first acknowledgement to the first message at a first acknowledgement transmission time t3, wherein the first acknowledgement transmission time t3 is the first message reception time t2 plus a first message duration time plus a predetermined constant.

In one or more implementations, a method includes transmitting, at a first station, a first message at a first message transmission time t1, wherein the first message has a first message duration time, and wherein the first message is to be received at a second station at a first message reception time t2. The method also includes receiving, at the first station, a first acknowledgement to the first message at a time-of-arrival estimation for the first acknowledgement, time t4, wherein the first acknowledgement is to be transmitted by the second station at a first acknowledgement transmission time t3, and wherein the first acknowledgement transmission time t3 is a time adjusted to be the first message reception time t2 plus the first message duration time plus a predetermined constant.

In one or more implementations, a first station is configured to receive a first message at a first message reception time t2, wherein the first message was transmitted by a second station at a first message transmission time t1, and wherein the first message includes a first message duration time. The first station is further configured to transmit a first acknowledgement to the first message at a first acknowledgement transmission time t3. The first acknowledgement transmission time t3 is the first message reception time t2 plus the first message duration time plus a predetermined constant.

In one or more implementations, a first station is configured to transmit a first message at a first message transmission time t1, wherein the first message has a first message duration time, and wherein the first message is to be received at a second station at a first message reception time t2. The first station also is configured to receive a first acknowledgement to the first message at a time-of-arrival estimation of the first acknowledgement, time t4, wherein the first acknowledgement is to be transmitted by the second station at a first acknowledgement transmission time t3, and wherein the first acknowledgement transmission time t3 is a time adjusted to be the first message reception time t2 plus the first message duration time plus a predetermined constant.

Above is a simplified Summary relating to one or more implementations described herein. As such, the Summary should not be considered an extensive overview relating to all contemplated aspects and/or implementations, nor should the Summary be regarded to identify key or critical elements relating to all contemplated aspects and/or implementations or to delineate the scope associated with any particular aspect and/or implementation. Accordingly, the Summary has the sole purpose of presenting certain concepts relating to one or more aspects and/or implementations relating to the mechanisms disclosed herein in a simplified form to precede the detailed description presented below.

### BRIEF DESCRIPTION OF THE DRAWINGS

FIG. 1 depicts a diagram of a broadband wireless network and timing of communications therein according to an example implementation of the technology described herein.

FIG. 2 is a flowchart of a method illustrating operation of a broadband wireless network according to an example implementation.

FIG. 3 is a flowchart of a method illustrating operation of a broadband wireless network according to an example implementation.

FIG. 4 is a flowchart of a method illustrating operation of a broadband wireless network according to an example implementation.

FIG. 5 is a block diagram of a broadband wireless network according to an example implementation of the technology described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

In general, one implementation of the subject matter disclosed herein is directed to time-of-departure (ToD) adjustment of acknowledgement frames (ACK) based on time-of-arrival (ToA) estimation and correction for their corresponding message frames in a broadband wireless network, with special application to round trip time (RTT) measurement (or ranging). Using the technology described herein, a sending station can determine a round trip time (RTT) with an accuracy of double-sided time-of-arrival (ToA) correction after a first transmission of a timing measurement frame (M) and receipt of a corresponding acknowledgement frame (ACK). Implementations may be based on the timing measurement exchange described in IEEE 802.11 standards, in which a receiving station uses its time-of-arrival (ToA) correction to adjust the transmission time of the acknowledgement frame (ACK) so that both the sending station and the receiving station can estimate the round trip time (RTT) at the same level of accuracy (with double-sided time-of-arrival (ToA) correction) with a minimum of frame exchanges.

### Example Broadband Wireless Network

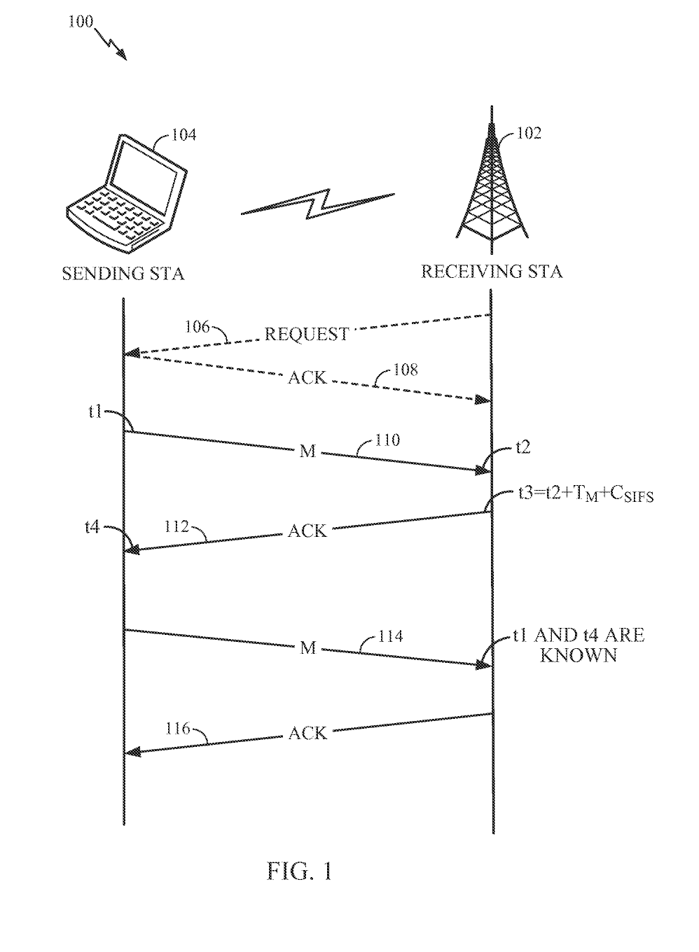

FIG. 1 depicts a broadband wireless network 100 and timing of communications in the broadband wireless network 100 according to an example implementation of the technology described herein. The broadband wireless network 100 may be used for double-sided time-of-departure (ToD) correction in Wi-Fi ranging.

The illustrated broadband wireless network 100 may be any communication system that is widely deployed to provide various types of communication content, such as voice, data, and so on. For example, the network 100 may be a multiple-access system that is configured to support communication with multiple users by sharing available system resources (e.g., bandwidth, transmit power, etc.).

Examples of such multiple-access systems include, but are not limited to, code division multiple access (CDMA) systems, time division multiple access (TDMA) systems, frequency division multiple access (FDMA) systems, orthogonal frequency division multiple access (OFDMA) systems, and others. These systems often are deployed in conformity with specifications such as third generation partnership project (3GPP), 3GPP long term evolution (LTE), ultra mobile broadband (UMB), evolution data optimized (EV-DO), and the like.

The illustrated network 100 is configured to support communication between several user devices and several base stations; however, for clarity, the network 100 is depicted with only a single user device, sending station 104, and a single base station, receiving station 102. Each sending station 104 may communicate with a receiving station 102 on a downlink (DL) and/or an uplink (UL). In general, a DL is a communication link from the receiving station 102 to the sending station 104, while an uplink (UL) is a communication link from the sending station 104 to the receiving station 102.

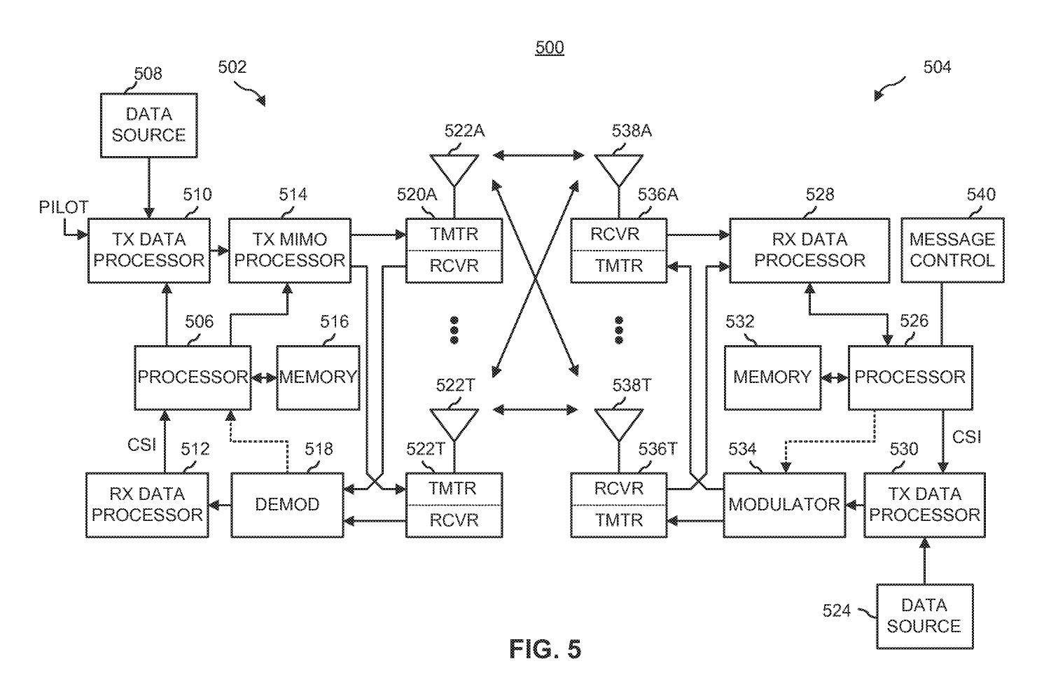

The receiving station 102 may be any entity that is configured to communicate with one or more sending stations 104, and may be referred to as a base station, a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology. The receiving station 102 is described in more detail with reference to FIG. 5.

In one or more implementations, the sending station 104 may be any user device and/or equipment such as a telephone, a tablet computer, a smartphone, a phablet, a laptop and desktop computer, a vehicle, or the like, and can be configured to connect with other devices either locally (e.g., Bluetooth, Wi-Fi, etc.) or remotely (e.g., via cellular networks, through the Internet, etc.) via the receiving station 102. The sending station 104 is described in more detail with reference to FIG. 5.

The illustrated network 100 may operate as follows. The receiving station 102 initiates ranging with the sending station 104 by transmitting a timing measurement request (REQUEST) 106 to the sending station 104. In response to the timing measurement request (REQUEST) 106, the sending station 104 transmits an acknowledgement frame (ACK) 108 to the receiving station 102.

The sending station 104 then transmits a timing measurement frame (M) 110 to the receiving station 102. The sending station 104 also captures the time-of-departure (ToD) of the timing measurement frame (M) 110 (e.g., the time stamp for transmitting the timing measurement frame (M) 110). In the illustrated implementation, the time-of-departure (ToD) for the timing measurement frame (M) 110 is time t1. Time t1 may be an approximation of the true over-the-air departure time for the start of the timing measurement frame (M) 110.

The receiving station 102 receives the timing measurement frame (M) 110 and captures the time-of-arrival (ToA) for the timing measurement frame (M) 110 (e.g., the time stamp for receiving the timing measurement frame (M) 110). In the illustrated implementation, the time-of-arrival (ToA) for the timing measurement frame (M) 110 is time t2. The time-of-arrival (ToA) estimation t2 by the receiving station 102 may be an estimate of the true over-the-air arrival time of the start of the timing measurement frame (M) 110.

Conventionally, in response to receiving the timing measurement frame (M) 110 the receiving station 102 would transmit an acknowledgement frame (ACK) 112 at a time t3, which is the time-of-arrival (ToA) estimation time t2 plus a frame length plus a short time interval (Short Interframe Space (SIFS)). For a given frame, the time between t2 and t3 is fairly constant, on the order of microseconds according to IEEE 802.11-2012 standards. The Media Access Control (MAC) layer in the receiving station 102 may control the transmission of the acknowledgement frame (ACK) 112 at time t3. The time-of-departure (ToD) estimation t3 (for the acknowledgement frame (ACK) 112) by the receiving station 102 may be an estimate of the true over-the-air departure time of the start of the acknowledgement frame (ACK) 112.

In one or more implementations of the technology described herein, the receiving station 102 applies a time-of-arrival (ToA) correction algorithm to adjust the time-of-arrival (ToA) for the timing measurement frame (M) 110 from an initial time-of-arrival (ToA) estimation to time t2. The receiving station 102 then transmits the acknowledgement frame (ACK) 112 at a time t3=t2+T_{M}+C_{SIFS}, where T_{M} represents the time duration of the first message (i.e., the first message time duration), and C_{SIFS} is a predetermined constant representing a short time interval (Short Interframe Space (SIFS)). The Media Access Control (MAC) layer in the receiving station 102 may control the transmission of the start of the acknowledgement frame (ACK) 112 over the air at time t3=t2+T_{M}+C_{SIFS}.

After the application of the ToA estimation/correction algorithms and ToD adjustment, the difference between the true over-the-air time-of-arrival (ToA) of the timing measurement frame (M) 110 and the true over-the-air time-of-departure (ToD) of its corresponding acknowledgement frame (ACK) 112 is controlled to be T_{M}+C_{SIFS}+E, where E is an error of a predetermined order (e.g., nanoseconds or lower for good ranging accuracy). The acknowledgement frame (ACK) 112 can include an indicator to inform the sending station 104 that the transmission time of the acknowledgement frame (ACK) 112 has been adjusted as such.

In one or more implementations of the technology described herein, the sending station 104 receives the acknowledgement frame (ACK) 112, captures the time-of-arrival (ToA) of the acknowledgement frame (ACK) 112 (e.g., the time stamp for receiving the acknowledgement frame (ACK) 112), and applies a time-of-arrival (ToA) correction algorithm to adjust the time-of-arrival (ToA) for the acknowledgement frame (ACK) 112 to time t4. The time-of-arrival (ToA) estimation t4 by the sending station 104 may be an estimate of the true over-the-air arrival time of the acknowledgement frame (ACK) 112.

While conventionally, the sending station 104 estimates a round trip time (RTT) with single-sided time-of-arrival (ToA) correction, using the technology described herein, the sending station 104 may estimate a round trip time (RTT) with double-sided time-of-arrival (ToA) correction as RTT=t4−t1−T_{M}−C_{SIFS}. The sending station 104 may send a follow-up timing measurement frame (M) 114 to the receiving station 102. The follow-up timing measurement frame (M) 114 includes the time stamps for time t1 and time t4 (or the difference between time t1 and time t4). The receiving station 102 receives the follow-up timing measurement frame (M) 114 and estimates a round trip time (RTT) with double-sided time-of-arrival (ToA) correction using time t4, time t1, T_{M} and C_{SIFS}. This follow-up timing measurement frame (M) 114 indicates that time t4 has time-of-arrival (ToA) estimation and correction algorithms applied. The receiving station 102 uses RTT=t4−t1−T_{M}−C_{SIFS} to calculate round trip time (RTT) with double-sided time-of-arrival (ToA) correction.

In one or more implementations, the receiving station 102 determines an initial coarse time-of-arrival (ToA) estimation t2′ of the true over-the-air arrival time to start processing the first timing measurement frame (M) 110. The receiving station 102 determines the first message's (timing measurement frame (M) 110) time duration T_{M} after initial processing of the first timing measurement frame (M) 110. The time duration T_{M} can be obtained from the packet preamble of the first timing measurement frame (M) 110. For example, the LENGTH information in the Signal field in the preamble of an IEEE 802.11 timing measurement frame (M) 110 may be used to determine the time duration T_{M}.

The receiving station 102 may set a transmission time for the acknowledgement frame (ACK) 112 to t2′+T_{M}+C_{SIFS} and apply the time-of-arrival (ToA) correction algorithm to refine the initial coarse time-of-arrival (ToA) estimation time t2′ to time t2. The receiving station 102 may adjust the transmission time for the acknowledgement frame (ACK) 112 from t2′+T_{M}+C_{SIFS} to t2+T_{M}+C_{SIFS} and transmit the acknowledgement frame (ACK) 112 at time t3=t2+T_{M}+C_{SIFS}. In one or more implementations, the time-of-arrival (ToA) correction algorithm uses information such as channel estimation, baseband, media access control (MAC), radio frequency (RF), and other processing delay information to refine the over-the-air time-of-arrival (ToA) estimation (or initial coarse time-of-arrival (ToA) estimation) from time t2′ to time t2.

It should be noted that in one or more implementations, time-of-arrival (ToA) correction can be used to control the transmission time of acknowledgement frames (ACKs) for general packets (not only timing measurement frames) to make the turn-around time more stable to the order of microseconds, nanoseconds, or even lower. In one implementation, acknowledgement frames (ACKs) may include an indicator that the transmission time of the acknowledgement frames (ACKs) has been adjusted to keep the turn-around time stable to a required order. Alternatively, a timing measurement request and/or exchanged message(s) may indicate or request that a receiving station adjust the transmission time of the corresponding acknowledgement frames (ACKs) to keep the turn-around time stable.

For ranging purpose, adjusted transmission time of the acknowledgement frame (ACK) by time-of-arrival (ToA) correction enables the ranging response station to estimate the round trip time (RTT) (or ranging) with the double-sided (instead of single-sided) time-of-arrival (ToA) correction accuracy right after receiving the acknowledgement frame (ACK) of the first timing measurement frame (M), while the ranging initiating station estimates the round trip time (RTT) (or ranging) with the same double-sided correction accuracy after receiving the second timing measurement frame (M).

Conventionally, in order to get the same level of ranging accuracy for the ranging response station (sending station), the entire procedure would have to be repeated, letting the sending station be a ranging initiating station. In order for both the sending station and the receiving station to obtain round trip time (RTT) with the double-sided correction accuracy, there would need to be two request frames, four timing measurement frames (M), and six acknowledgement frames (ACKs). Implementations of the technology described herein reduce the number of frame transmissions by half and hence alleviate network congestion.

In one or more implementations, a bit can be added in the acknowledgement frame (ACK) as an indication on a per acknowledgement frame (ACK) basis to denote whether the transmission time of an acknowledgement frame (ACK) has been adjusted. Alternatively, information regarding whether the transmission time of an acknowledgement frame (ACK) has been adjusted can be added in one or more measurement frames to indicate that the receiving station will always adjust the transmission time of acknowledgement frames (ACKs).

In some implementations, adjusting transmission time of acknowledgement frames (ACKs) can be applied to non-802.11 timing measurement frames as well to enable ranging capability not based on 802.11 timing measurement protocols. In this example, only two frames may be used (e.g., a frame (M) from the sending station and an acknowledgement frame (ACK) from the receiving station). The benefit of double-sided time-of-arrival (ToA) correction is acquired at the sending station for ranging purposes.

In one or more implementations, the time-of-arrival (ToA) estimation is carried out based on channel estimation, which includes the first arriving signal path or the direct path information from the sending station to the receiving station. In one or more implementations, the time-of-arrival (ToA) correction algorithm is based at least in part on channel estimation, radio frequency (RF) information including the receiving radio frequency (RF) delay information and the receiving-to-transmitting radio frequency (RF) turnaround delay information, MAC processing delays in the receiving station, baseband signal information and processing delays in the receiving station, etc.

### Example Broadband Wireless Network Operations

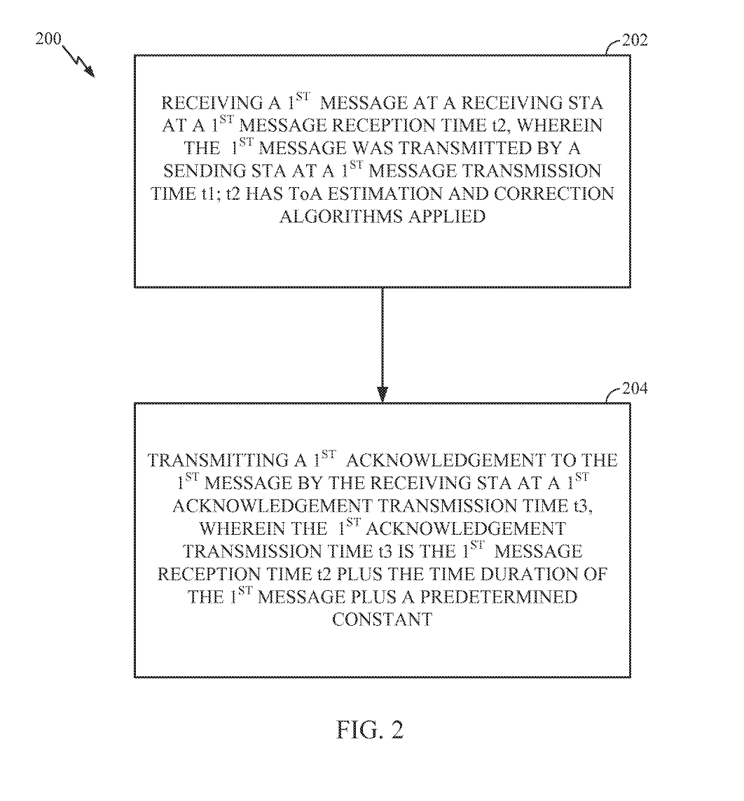

FIG. 2 is a flowchart of a method 200 illustrating operation of a broadband wireless network according to the technology described herein. In one or more implementations, the broadband wireless network adjusts the transmission time of an acknowledgement to a message for a receiving station in the broadband wireless network to make the turn-around time of the acknowledgement stable.

For purposes of explanation, assume that receiving station 102 has initiated ranging with the sending station 104 by transmitting a timing measurement request (REQUEST) 106 to the sending station 104. The timing measurement request (REQUEST) 106 or messages exchanged between the sending station and the receiving station may request that the receiving station adjust the transmission time of the acknowledgement frame (ACK) to keep the turn-around time stable. Assume further that in response to the timing measurement request (REQUEST) 106, the sending station 104 has transmitted an acknowledgement frame (ACK) 108 to the receiving station 102.

In a block 202, the method 200 operates by receiving a first message at a receiving station (e.g., receiving station 102) at a first message reception time t2. In this and other implementations, the first message was transmitted by a sending station (e.g., sending station 104) at a first message transmission time t1. The first message reception time t2 has time-of-arrival (ToA) estimation and correction algorithms applied.

In a block 204, the method 200 operates by transmitting a first acknowledgement to the first message by the receiving station at a first acknowledgement transmission time t3.

In this and other implementations, the first acknowledgement transmission time t3 is the first message reception time t2 plus the time duration of the first message plus a predetermined constant.

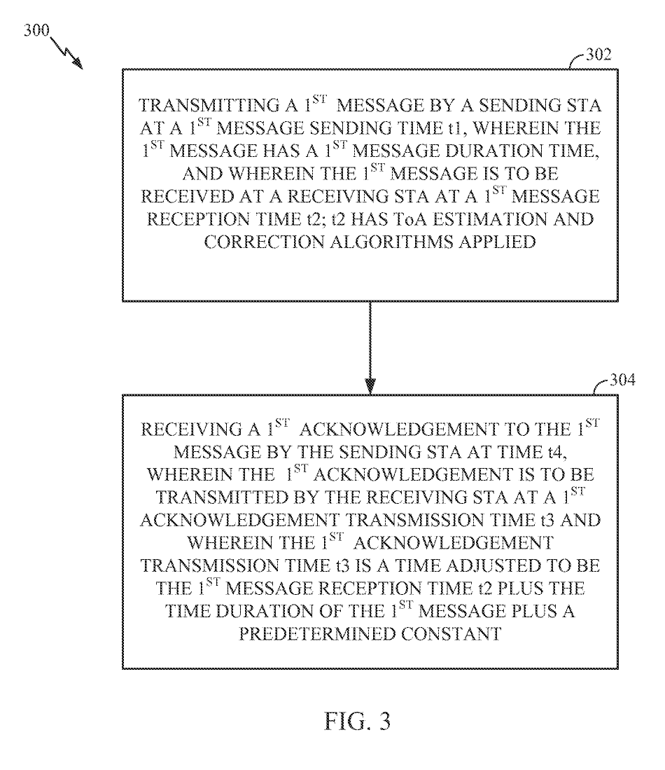

FIG. 3 is a flowchart of a method 300 illustrating operation of a broadband wireless network according to the technology described herein. In one or more implementations, the broadband wireless network determines a round trip time (RTT) between two stations (i.e. sending station 104 and receiving station 102) in the broadband wireless network.

Again, for purposes of explanation, assume that receiving station 102 has initiated ranging with the sending station 104 by transmitting a timing measurement request (REQUEST) 106 to the sending station 104. The timing measurement request (REQUEST) 106 or messages exchanged between the sending station and the receiving station may request that the receiving station adjust the transmission time of the acknowledgement frame (ACK) to keep the turn-around time stable. Assume further that in response to the timing measurement request (REQUEST) 106, the sending station 104 has transmitted an acknowledgement frame (ACK) 108 to the receiving station 102.

In a block 302, the method 300 operates by transmitting a first message by a sending station (e.g., sending station 104) at a first message transmission time t1, wherein the first message has a first message duration time and the first message is to be received at a receiving station (e.g., receiving station 102) at a first message reception time t2. The first message reception time t2 has time-of-arrival (ToA) estimation and correction algorithms applied.

In a block 304, the method 300 operates by receiving a first acknowledgement to the first message by the sending station at time t4, wherein the first acknowledgement is to be transmitted by the receiving station at a first acknowledgement transmission time t3, and wherein the first acknowledgement transmission time t3 is a time adjusted to be the first message reception time t2 plus the time duration of the first message plus a predetermined constant.

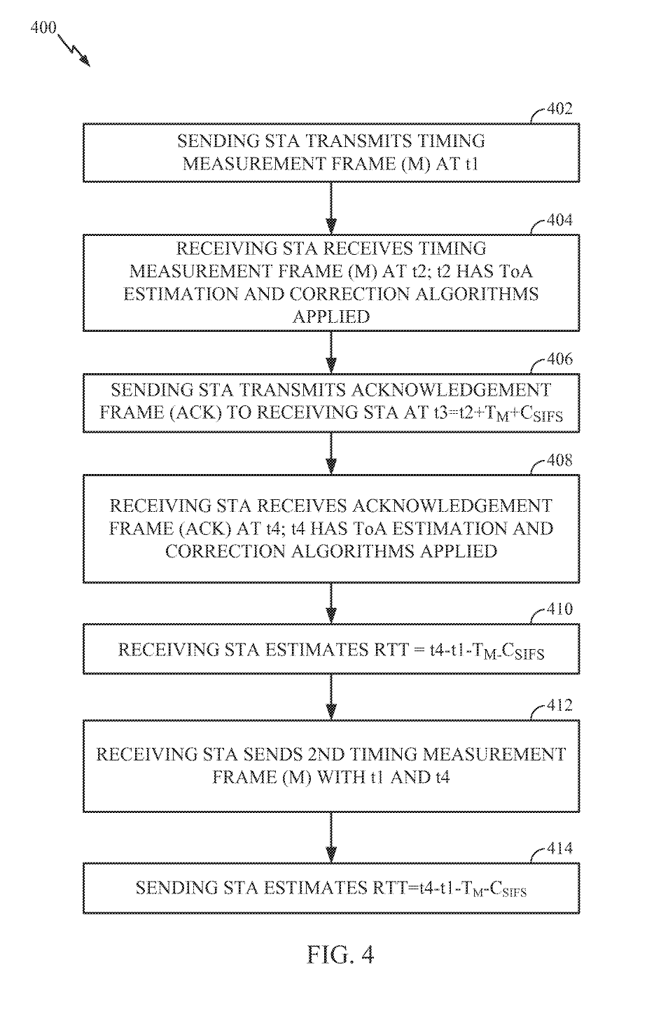

FIG. 4 is a flowchart of a method 400 illustrating operation of a broadband wireless network according to the technology described herein. In one or more implementations, the broadband wireless network adjusts the transmission time of an acknowledgement frame (ACK) for a receiving station to make the turn-around time of the acknowledgement frame (ACK) stable to a predefined order of precision (e.g., microseconds, nanoseconds, or lower). The acknowledgement frame (ACK) may include an indicator that the transmission time of the acknowledgement frame (ACK) has been adjusted to keep the turn-around time stable.

As before, for purposes of explanation, assume that receiving station 102 has initiated ranging with the sending station 104 by transmitting a timing measurement request (REQUEST) 106 to the sending station 104. The timing measurement request (REQUEST) 106 or messages exchanged between the sending station and the receiving station may request that the receiving station adjust the transmission time of the acknowledgement frame (ACK) to keep the turn-around time stable. Assume further that in response to the timing measurement request (REQUEST) 106, the sending station 104 has transmitted an acknowledgement frame (ACK) 108 to the receiving station 102.

In a block 402, the sending station 104 transmits the timing measurement frame (M) 110 to the receiving station 102 at time t1. In one or more implementations, the time t1 may be an approximation of the true over-the-air departure time of the start of the timing measurement frame (M) 110 from the sending station 104.

In a block 404, the receiving station 102 receives the timing measurement frame (M) 110 at time t2. In one or more implementations, the receiving station 102 determines an initial coarse time-of-arrival (ToA) estimation t2′ of the true over-the-air arrival time to start processing the timing measurement frame (M) 110.

After initial processing of the timing measurement frame (M) 110, the receiving station 102 determines the timing measurement frame (M) 110's time duration T_{M}, and applies a time-of-arrival (ToA) correction algorithm to refine the time-of-arrival (ToA) estimation (or initial coarse time-of-arrival (ToA) estimation) from t2′ to t2. In one or more implementations, the time-of-arrival (ToA) correction algorithm uses information such as channel estimation, baseband, radio frequency (RF), and other processing delay information. In one or more implementations, the time-of-arrival (ToA) for the timing measurement frame (M) 110 at time t2 may be an estimate of the true over-the-air arrival time of the start of the timing measurement frame (M) 110.

In a block 406, the receiving station 102 transmits an acknowledgement frame (ACK) 112 to the sending station 104 at time t3=t2+T_{M}+C_{SIFS}, where T_{M} represents a time duration of the timing measurement frame (M) 110, and where C_{SIFS} is a predetermined constant representing the short time interval (Short Interframe Space (SIFS). In one or more implementations, the time-of-departure (ToD) time t3 from the receiving station 102 of the acknowledgement frame (ACK) 112 may be an approximation of the true over-the-air departure time of the start of the acknowledgement frame (ACK) 112. The acknowledgement frame (ACK) 112 also may include an indicator that the transmission time of the acknowledgement frame (ACK) 112 has been adjusted to keep the turn-around time stable to a predefined order of precision.

At a block 408, the sending station 104 receives the acknowledgement frame (ACK) 112 at time t4. In one or more implementations, the sending station 104 determines an initial coarse time-of-arrival (ToA) estimation t4′ of the true over-the-air arrival time to start processing the acknowledge frame (ACK) 112. After initial processing of the acknowledge frame (ACK) 112, the sending station 104 applies a time-of-arrival (ToA) correction algorithm to refine the time-of-arrival (ToA) estimation from the initial coarse time-of-arrival estimation time t4′ to t4. In one or more implementations, the time-of arrival (ToA) for the acknowledge frame (ACK) 112 at time t4 may be an estimate of the true over-the-air arrival time of the start of the acknowledge frame (ACK) 112.

In a block 410, the sending station 104 calculates/estimates a round trip time (RTT) or ranging using RTT=t4−t1−T_{M}−C_{SIFS}.

In a block 412, the sending station 104 sends a second timing measurement frame (M) 114 along with the times t1 and t4 (or the difference) to the receiving station 102. The second timing measurement frame (M) 114 may indicate that the time-of-arrival estimation and the correction algorithms have been applied to the time t4.

In a block 414, the receiving station 102 receives the second timing measurement frame (M) 114 and calculates/estimates the round trip time (RTT) or ranging using RTT=t4−t1−T_{M}−C_{SIFS}.

### Example Broadband Wireless Network Logic/Circuitry

FIG. 5 is a block diagram of a broadband wireless network 500 according to an example implementation of the technology described herein, in which a mechanism for time-of-departure (ToD) adjustment of acknowledgement frames based on time-of-arrival (ToA) correction can be implemented. For instance, a user device 502 may be the sending station 104, and a base station 504 may be the receiving station 102.

As an example, the base station 504 is configured to receive a first message at a first message reception time t2, wherein the first message was transmitted by the user device 502 at a first message transmission time t1. The base station 504 also may be configured to transmit a first acknowledgement to the first message at a first acknowledgement transmission time t3, wherein the first acknowledgement transmission time t3 is the first message reception time t2 plus the first message duration time plus a predetermined constant.

The base station 504 is further configured to determine an initial coarse time-of-arrival estimation time t2′ of the true over-the-air arrival time to start an initial processing of the first message, determine a time duration of the first message after initial processing of the first message, set a first acknowledgement transmission time to the initial coarse time-of-arrival estimation time t2′ plus the time duration of the first message plus the predetermined constant, apply a time-of-arrival (ToA) correction algorithm to refine the initial coarse time-of-arrival estimation time t2′ to the first message reception time t2, adjust the first acknowledgement transmission time from the initial coarse time-of-arrival estimation time t2′ plus the time duration of the first message plus the predetermined constant to the first message reception time t2 plus the time duration of the first message plus the predetermined constant, and transmit the first acknowledgement to the first message at the first acknowledgement transmission time t3, wherein the first acknowledgement transmission time t3 is first message reception time t2 plus the time duration of the first message plus the predetermined constant.

As an alternative example, the user device 502 is configured to transmit a first message at a first message transmission time t1. The first message has a first message duration time. The base station 504 is configured to receive the first message at a first message reception time t2 and to transmit a first acknowledgement to the first message at a first acknowledgement transmission time t3. The base station 504 is further configured to adjust the first acknowledgement transmission time t3 to be the first message reception time t2 plus the first message duration time plus a predetermined constant. The user device 502 is further configured to receive the first acknowledgement to the first message at a time-of-arrival estimation of the first acknowledgement, time t4.

The user device 502 is further configured to determine the time-of-arrival estimation of the first acknowledgement, time t4 as an approximation of the true over-the-air arrival time of the first acknowledgement to the first message and calculate a round trip time (RTT) estimation using the time-of-arrival estimation of the first acknowledgement time t4, the first message transmission time t1, the first message duration time, and the predetermined constant. The user device 502 also is further configured to transmit a second message, wherein the second message includes the time-of-arrival estimation of a start of first acknowledgement time t4 and the first message transmission time t1.

The user device 502 is further configured to receive the second message and to calculate a round trip time (RTT) estimation using the time-of-arrival estimation of the start of first acknowledgement, time t4, the first message transmission time t1, the first message duration time, and the predetermined constant.

The user device 502 is further configured to determine the time-of-arrival estimation of the first acknowledgement, time t4, as an approximation of the true over-the-air arrival time of the first acknowledgement to the first message, and calculate a round trip time (RTT) estimation using the time-of-arrival estimation of the first acknowledgement, time t4, the first message transmission time t1, the first message duration time, and the predetermined constant.

The user device 502 is further configured to transmit a second message. The second message includes the time-of-arrival estimation of a start of the first acknowledgement, time t4, and the first message transmission time t1. The user device 502 is further configured to receive the second message and to calculate a round trip time (RTT) estimation using the time-of-arrival estimation of the start of first acknowledgement, time t4, the first message transmission time t1, the first message duration time, and the predetermined constant.

In the illustrated implementation, the user device 502 includes a processor 506, a data source 508, a transmit (TX) data processor 510, a receive (RX) data processor 512, a transmit (TX) (multiple-input multiple-output (MIMO) processor 514, a memory 516, a demodulator (DEMOD) 518, several transceivers 520A through 520T, and several antennas 522A through 522T.

In the illustrated implementation, the user device 504 includes a data source 524, a processor 526, a receive data processor 528, a transmit data processor 530, a memory 532, a modulator 534, several transceivers 536A through 536T, several antennas 538A through 538T, and a message control module 540.

The illustrated user device 502 may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, the user device 502 may be a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

The illustrated base station 504 may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

The illustrated data source 508 provides traffic for a number of data streams to the transmit (TX) data processor 510.

The transmit (TX) data processor 510 formats, codes, and interleaves the traffic data for each data stream based on a particular coding scheme selected for that data stream to provide coded data. The coded data for each data stream may be multiplexed with pilot data using OFDM techniques.

The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols.

The data rate, coding, and modulation for each data stream may be determined by instructions performed by the processor 510. The memory 516 may store program code, data, and other information used by the processor 510 or other components of the user device 502.

The modulation symbols for all data streams are then provided to the TX MIMO processor 514, which may further process the modulation symbols (e.g., for OFDM). The TX MIMO processor 514 then provides N_{T} modulation symbol streams to the N_{T} transceivers (XCVR) 520A through 520T. In some implementations, the TX MIMO processor 514 applies beam-forming weights to the symbols of the data streams and to the antenna from which the symbol is being transmitted.

Each transceiver (XCVR) 520A through 520T receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers (XCVR) 520A through 520T are then transmitted from N_{T} antennas 522A through 522T, respectively.

At the base station 504, the transmitted modulated signals are received by N_{R} antennas 538A through 538R and the received signal from each antenna 538A through 538R is provided to a respective transceiver (XCVR) 536A through 536R. Each transceiver (XCVR) 536A through 536R conditions (e.g., filters, amplifies, and downconverts) a respective received signal, digitizes the conditioned signal to provide samples, and further processes the samples to provide a corresponding “received” symbol stream.

The receive (RX) data processor 528 then receives and processes the N_{R} received symbol streams from the N_{R} transceivers (XCVR) 536A through 536R based on a particular receiver processing technique to provide N_{T} “detected” symbol streams. The receive (RX) data processor 528 then demodulates, deinterleaves, and decodes each detected symbol stream to recover the traffic data for the data stream. The processing by the receive (RX) data processor 528 is complementary to that performed by the transmit (TX) MIMO processor 514 and the transmit (TX) data processor 510 at the user device 502.

The processor 526 periodically determines which pre-coding matrix to use (discussed below). The processor 526 formulates a reverse link message comprising a matrix index portion and a rank value portion.

The data memory 532 may store program code, data, and other information used by the processor 526 or other components of the base station 504.

The reverse link message may comprise various types of information regarding the communication link and/or the received data stream. The reverse link message is then processed by a TX data processor 530, which also receives traffic data for a number of data streams from the data source 524, modulated by the modulator 534, conditioned by the transceivers (XCVR) 536A through 536R, and transmitted back to the user device 502.

At the user device 502, the modulated signals from the base station 504 are received by the antennas 522A through 522T, conditioned by the transceivers (XCVR) 520A through 520R, demodulated by a demodulator (DEMOD) 518, and processed by the RX data processor 512 to extract the reverse link message transmitted by the base station 504. The processor 510 then determines which pre-coding matrix to use for determining the beam-forming weights then processes the extracted message.

It should be appreciated that for the user device 502 and the base station 504 the functionality of two or more of the described components may be provided by a single component. For example, a single processing component may provide the functionality of the message control component 540 and the processor 526.

It also should be appreciated that a wireless node may be configured to transmit and/or receive information in a non-wireless manner (e.g., via a wired connection). Thus, a receiver and a transmitter as discussed herein may include appropriate communication interface components (e.g., electrical or optical interface components) to communicate via a non-wireless medium.

The network 500 may implement any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards.

A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS).

The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2).

Although certain aspects of the disclosure may be described using 3GPP terminology, it is to be understood that the teachings herein may be applied to 3GPP (e.g., Re199, Re15, Re16, Re17) technology, as well as 3GPP2 (e.g., 1×RTT, 1×EV-DO Re10, RevA, RevB) technology and other technologies.

Aspects of the technology described herein and related drawings are directed to specific implementations of the technology. Alternative implementations may be devised without departing from the scope of the technology described herein. Additionally, well-known elements of the technology will not be described in detail or will be omitted so as not to obscure the relevant details.

Although steps and decisions of various methods may have been described serially in this disclosure, some of these steps and decisions may be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. It should be noted, however, that in selected variants the steps and decisions are performed in the order described above. Furthermore, not every illustrated step and decision may be required in every implementation/variant in accordance with the technology described herein, while some steps and decisions that have not been specifically illustrated may be desirable or necessary in some implementation/variants in accordance with the technology described herein.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software, or combinations of both. To show clearly this interchangeability of hardware and software, various illustrative components, blocks, modules, circuits, and steps have been described above generally in terms of their functionality. Whether such functionality is implemented as hardware, software, or combination of hardware and software depends upon the particular application and design constraints imposed on the overall system. Skilled artisans may implement the described functionality in varying ways for each particular application, but such implementation decisions should not be interpreted as causing a departure from the scope of the present technology described herein.

The various illustrative logical blocks, modules, and circuits described in connection with the implementation disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be implemented directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an access terminal. Alternatively, the processor and the storage medium may reside as discrete components in an access terminal.

The previous description of the disclosed implementations is provided to enable any person skilled in the art to make or use the technology described herein. Various modifications to these implementations will be readily apparent to those skilled in the art, and the generic principles defined herein may be applied to other implementations without departing from the spirit or scope of the technology described herein. Thus, aspects of the technology described herein are not intended to be limited to the implementations shown herein, but is to be accorded the widest scope consistent with the principles and novel features disclosed herein.

What is claimed is:

1. A method for adjusting a transmission time of an acknowledgement to a message for a first station in a wireless communication network, the method comprising:
receiving, at the first station, a first message at a first message reception time t2, wherein the first message was transmitted by a second station at a first message transmission time t1, and wherein the first message has a first message duration time; and
transmitting, at the first station, a first acknowledgement to the first message at a first acknowledgement transmission time t3, wherein the first acknowledgement transmission time t3 is the first message reception time t2 plus the first message duration time plus a predetermined constant.

2. The method of claim 1, wherein the first acknowledgement to the first message includes an indicator that the first acknowledgement transmission time t3 has been adjusted.

3. The method of claim 1, wherein the first message requests that the first station adjust the first acknowledgement transmission time t3.

4. The method of claim 1, wherein the first message reception time t2 is a time-of-arrival (ToA) estimation of a true over-the-air arrival time of a start of the first message.

5. The method of claim 1, wherein the first acknowledgement transmission time t3 is a time-of-departure approximation of a true over-the-air departure time of a start of the first acknowledgement to the first message.

6. The method of claim 1, further comprising:
determining, at the first station, an initial coarse time-of-arrival estimation time t2′ of the true over-the-air arrival time to start an initial processing of the first message;
determining, at the first station, the first message duration time after initial processing of the first message;
setting, at the first station, the first acknowledgement transmission time t3 to the initial coarse time-of-arrival estimation time t2′ plus the first message duration time plus the predetermined constant;
applying, at the first station, a time-of-arrival correction algorithm to refine the initial coarse time-of-arrival estimation time t2′ to be the first message reception time t2;
adjusting, at the first station, the first acknowledgement transmission time t3 from the initial coarse time-of-arrival estimation t2′ plus the first message duration time plus the predetermined constant to the first message reception time t2 plus the first message duration time plus the predetermined constant; and
transmitting, at the first station, the first acknowledgement to the first message at the first acknowledgement transmission time t3, wherein the first acknowledgement transmission time t3 is the first message reception time t2 plus the first message duration time plus the predetermined constant.

7. The method of claim 6, wherein determining the first message duration time after initial processing of the first message comprises capturing the first message duration time from a preamble of a packet for the first message.

8. The method of claim 6, wherein the time-of-arrival correction algorithm is based at least in part on channel estimation information, wherein the channel estimation information includes information on at least one of a first arrival signal path and a direct path between the second station and the first station.

9. The method of claim 6, wherein the time-of-arrival correction algorithm is based at least in part on radio frequency (RF) information, wherein the radio frequency (RF) information includes at least one of a receiving radio frequency (RF) delay information and a receiving-to-transmitting radio frequency (RF) turnaround delay information.

10. The method of claim 6, wherein the time-of-arrival correction algorithm is based at least in part on media access control (MAC) processing delays in the first station.

11. The method of claim 6, wherein the time-of-arrival correction algorithm is based at least in part on at least one of baseband signal information and processing delays in the first station.

12. A method for determining a round trip time (RTT) between two stations in a wireless communication network, the method comprising:
transmitting, at a first station, a first message at a first message transmission time t1, wherein the first message has a first message duration time, and wherein the first message is to be received at a second station at a first message reception time t2; and
receiving, at the first station, a first acknowledgement to the first message at a time-of-arrival estimation of the first acknowledgement, time t4, wherein the first acknowledgement is to be transmitted by the second station at a first acknowledgement transmission time t3, and wherein the first acknowledgement transmission time t3 is a time adjusted to be the first message reception time t2 plus the first message duration time plus a predetermined constant.

13. The method of claim 12, further comprising:
determining, at the first station, the time-of-arrival estimation of the first acknowledgement, time t4, as an approximation of the true over-the-air arrival time of the first acknowledgement to the first message; and
calculating, at the first station, a round trip time (RTT) estimation using the time-of-arrival estimation of the first acknowledgement, time t4, the first message transmission time t1, the first message duration time, and the predetermined constant.

14. The method of claim 13, further comprising determining, at the first station, the round trip time (RTT) estimation as the time-of-arrival estimation, time t4, minus the first message transmission time t1 minus the first message duration time minus the predetermined constant.

15. The method of claim 12, wherein the first message transmission time t1 is an approximation of a true over-the-air departure time of a start of a first message transmission from the first station.

16. The method of claim 12, further comprising:
transmitting, at the first station, a second message, wherein the second message includes a start for the time-of-arrival estimation of the first acknowledgement, time t4, and the first message transmission time t1;
receiving, at the second station, the second message; and
calculating, at the second station, a round trip time (RTT) estimation using the time-of-arrival estimation of the first acknowledgement, time t4, the first message transmission time t1, the first message duration time, and the predetermined constant.

17. The method of claim 16, wherein the second message indicates that the time-of-arrival estimation of the first acknowledgement, time t4, has a time-of-arrival correction algorithm applied.

18. The method of claim 16, wherein the round trip time (RTT) estimation at the second station is determined as the time-of-arrival estimation of the first acknowledgement, time t4, minus the first message transmission time t1 minus the first message duration time minus the predetermined constant.

19. An apparatus, comprising:
a first station configured to:
receive a first message at a first message reception time t2, wherein the first message was transmitted by a second station at a first message transmission time t1, and wherein the first message has a first message duration time; and
transmit a first acknowledgement to the first message at a first acknowledgement transmission time t3, wherein the first acknowledgement transmission time t3 is the first message reception time t2 plus the first message duration time plus a predetermined constant.

20. The apparatus of claim 19, wherein the first station is further configured to:
determine an initial coarse time-of-arrival estimation time t2′ of the true over-the-air arrival time to start an initial processing of the first message;
determine the first message duration time after initial processing of the first message;
set a first acknowledgement transmission time t3 to the initial coarse time-of-arrival estimation time t2′ plus the first message duration time plus the predetermined constant;
apply a time-of-arrival correction algorithm to refine the initial coarse time-of-arrival estimation time t2′ to the first message reception time t2;
adjust the first acknowledgement transmission time t3 from the initial coarse time-of-arrival estimation time t2′ plus the first message duration time plus the predetermined constant to the first message reception time t2 plus the first message duration time plus the predetermined constant; and
transmit the first acknowledgement to the first message at the first acknowledgement transmission time t3, wherein the first acknowledgement transmission time t3 is first message reception time t2 plus the first message duration time plus the predetermined constant.

21. An apparatus, comprising:
a first station configured to:
transmit a first message at a first message transmission time t1, wherein the first message has a first message duration time, and wherein the first message is to be received at a second station at a first message reception time t2; and
receive a first acknowledgement to the first message at a time-of-arrival estimation of the first acknowledgement, time t4, wherein the first acknowledgement is to be transmitted by the second station at a first acknowledgement transmission time t3, and wherein the first acknowledgement transmission time t3 is a time adjusted to be the first message reception time t2 plus the first message duration time plus a predetermined constant.

22. The apparatus of claim 21, wherein the first station is further configured to:
determine the time-of-arrival estimation of the first acknowledgement, time t4, as an approximation of the true over-the-air arrival time of the first acknowledgement to the first message; and
calculate a round trip time (RTT) estimation using the time-of-arrival estimation of the first acknowledgement, time t4, the first message transmission time t1, the first message duration time, and the predetermined constant.

23. The apparatus of claim 22, wherein the first station is further configured to calculate the round trip time (RTT) estimation as the time-of-arrival estimation, time t4, minus the first message transmission time t1 minus the first message duration time minus the predetermined constant.
